(19) United States
(12) Patent Application Publication
(10) Pub. No.: US 2009/0255756 A1
(43) Pub. Date: Oct. 15, 2009

(54) HARNESS WITH INTEGRATED FALL ARREST SYSTEM

(76) Inventor: Sherry Jean Green, Jasper, GA (US)

Correspondence Address: AKERMAN SENTERFITT, P.O. BOX 3188, WEST PALM BEACH, FL, 33402-3188, US

(21) Appl. No.: 12/335,317

(22) Filed: Dec. 15, 2008

Related U.S. Application Data
(60) Provisional application No. 61/013,452, filed on Dec. 13, 2007.

(51) Int. Cl. A62B 35/04; A62B 35/00

(52) U.S. Cl. 182/3

(57) ABSTRACT

A fall arrest system formed from a suspension seat supported by a plurality of shoulder straps coupled to an adjustable waist belt is disclosed. The suspension seat formed from a platform that is suspended beneath the adjustable waist belt such that the suspension seat is positioned generally vertically with straps that include breakable connections. During a fall, the breakable connections break and the suspension seat falls into a horizontal position to support a person about which the fall arrest system is attached. During the fall, a self extraction ladder may also be deployed. The fall arrest system may also include fabric layers attached to front and rear sides of shoulder straps. In addition, the side areas under a user's arms between the front and rear sides are open.

### CROSS-REFERENCE TO RELATED APPLICATION

This patent application claims the benefit of U.S. Provisional Patent Application No. 61/013,452, filed Dec. 13, 2007, which is incorporated by reference in its entirety.

### FIELD OF THE INVENTION

This invention is directed to fall arrest systems and more particularly to fall arrest systems capable of safe self extraction by the user.

### BACKGROUND OF THE INVENTION

Harness systems are used across a wide range of applications to prevent users from falling and to suspend a user above the ground. Many harness systems that are used for fall prevention systems are designed to be as least obstructive as possible. Thus, many of these systems include a leg strap for each leg that is about ¾ of an inch to about 2 inches in width. During a fall, the leg straps slide into the groin of the user, thereby cutting off the blood circulation back to the user's heart. Some systems inadvertently cut off circulation to such an extent that death occurs in little over five minutes. Thus, a user must quickly relieve the pressure on the inner portions of the user's legs. Such a system is ineffective.

### SUMMARY OF THE INVENTION

The fall arrest system may be formed from a plurality of shoulder straps coupled to an adjustable waist belt. A suspension seat formed from a platform may be suspended beneath the adjustable waist belt such that the suspension seat is positioned generally vertically with straps that include breakable connections. A first strap extends between the suspension seat and a rear portion of the adjustable waist belt. The first strap may be attached to the suspension seat proximate to a first, upper corner of the suspension seat. The first strap may include at least one first loop affixed with a breakable connection. A second strap may extend between the suspension seat and a rear portion of the adjustable waist belt. The second strap may be attached to the suspension seat proximate to a second, upper corner of the suspension seat. The second strap may include at least one second loop affixed with a breakable connection. At least one first front support strap may extend from a first lower corner of the suspension seat to a front portion of the adjustable waist strap. At least one second front support strap may extend from a second lower corner of the suspension seat to a front portion of the adjustable waist strap. The at least one first and second front support straps may be adjustable. The suspension seat may be positioned generally vertically prior to a fall, and the at least one first and second loops may be sized such that after a fall, the breakable connections break and the suspension seat is positioned in a generally horizontal position.

The at least one of the shoulder straps may be adjustable. The plurality of shoulder straps may be coupled to a back pad positioned proximate to a user's upper back. A chest strap may extend between the shoulder straps on a front side positioned proximate to a user's chest. A coupling may be attached on each hip of the adjustable waist strap to which a climbing belt may be attached. Fabric layers may be attached to front and rear sides of shoulder straps, wherein side areas under a user's arms between the front and rear sides are open. Pockets may be included in the outer surface of the fabric layers. The fall arrest system may include an automatically deployable self extraction ladder.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a perspective view of a partial fall arrest system without a suspension seat.

FIG. 2 is a perspective view of a fall arrest system with a suspension seat.

FIG. 3 is a perspective view of an alternative embodiment of a fall arrest system with a suspension seat.

FIG. 4 is a perspective view of the fall arrest system of FIG. 3 in a fall situation.

FIG. 5 is a perspective view of a climbing belt of the fall arrest system.

FIG. 6 is a side view of a tether attaching the fall arrest system to a tree.

FIG. 7 is a schematic diagram of the fall arrest system during use in a fall situation.

FIG. 8 is a front view of another embodiment of the fall arrest system in which the fall arrest system is incorporated within a gadget harness.

FIG. 9 is a rear view of the fall arrest system of FIG. 8.

FIG. 10 is a front view of the fall arrest system of FIG. 8.

FIG. 11 is a rear view of the fall arrest system of FIG. 8.

FIG. 12 is a side view of the fall arrest system of FIG. 8.

FIG. 13 is a detailed side view of the fall arrest system of FIG. 8.

### DETAILED DESCRIPTION OF THE INVENTION

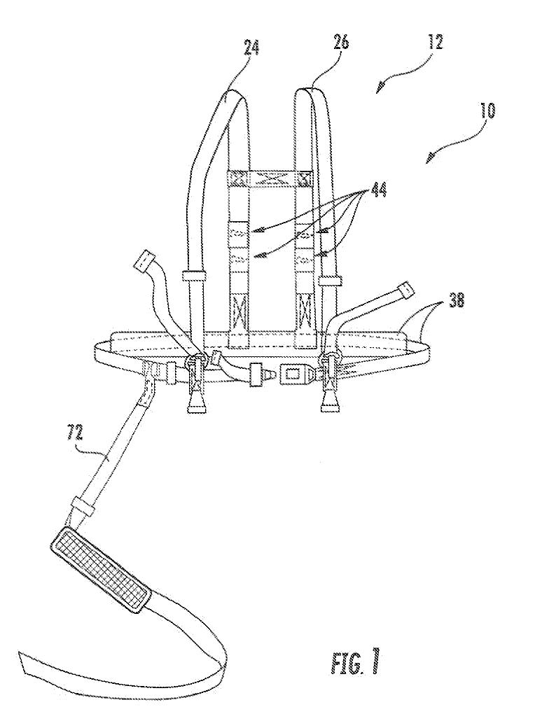

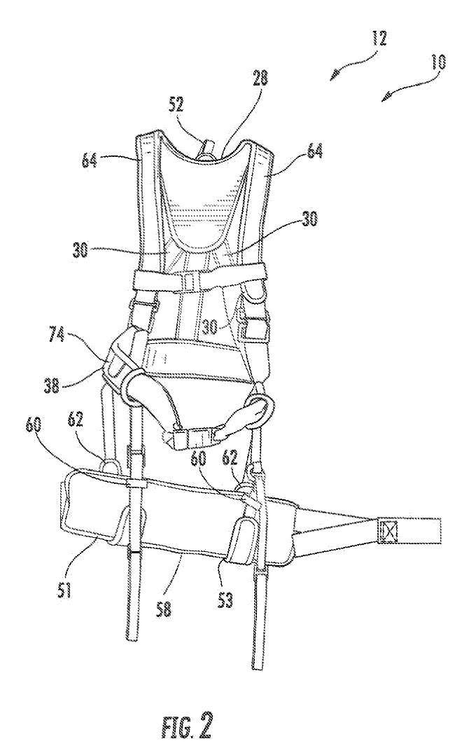

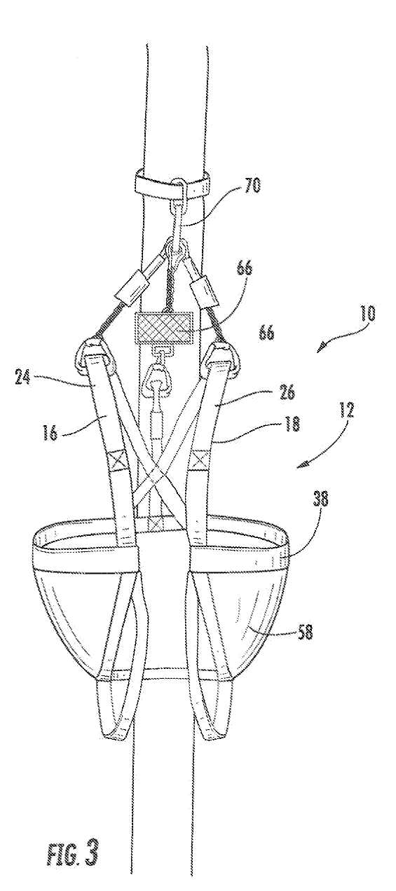

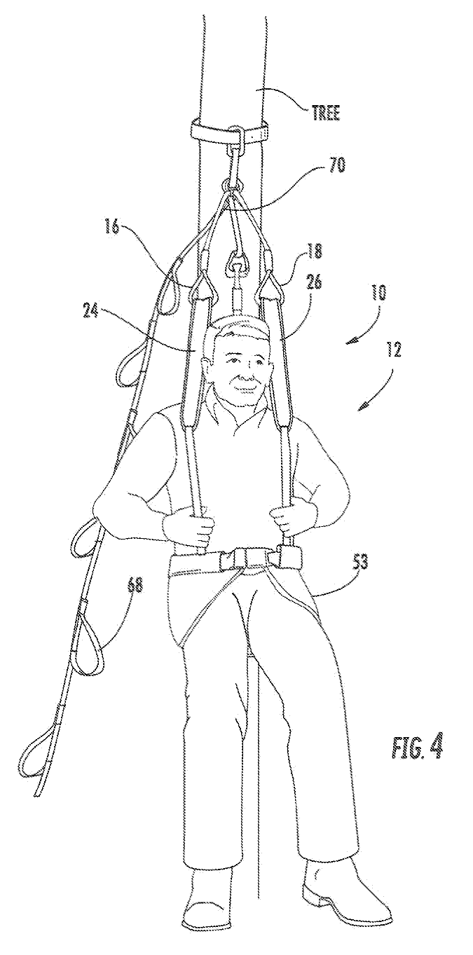

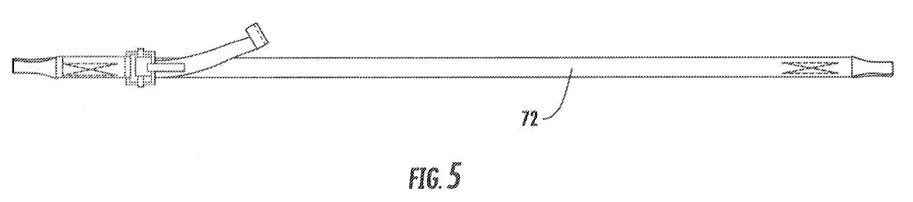

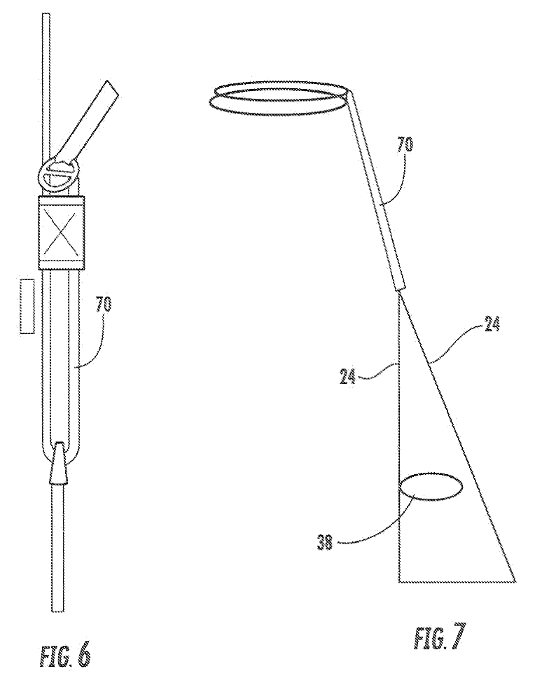

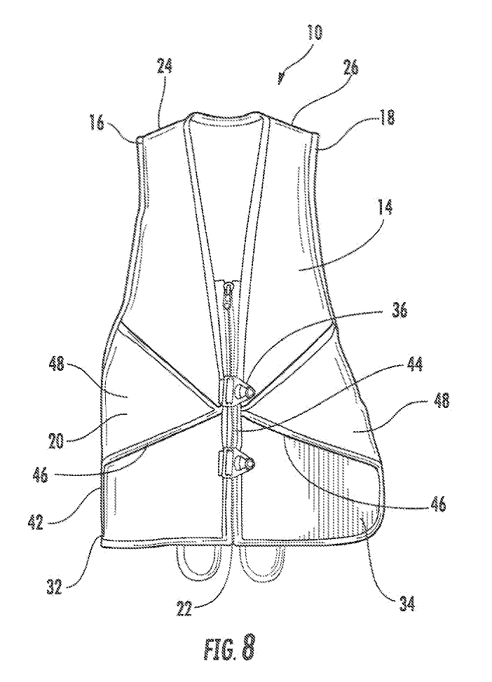

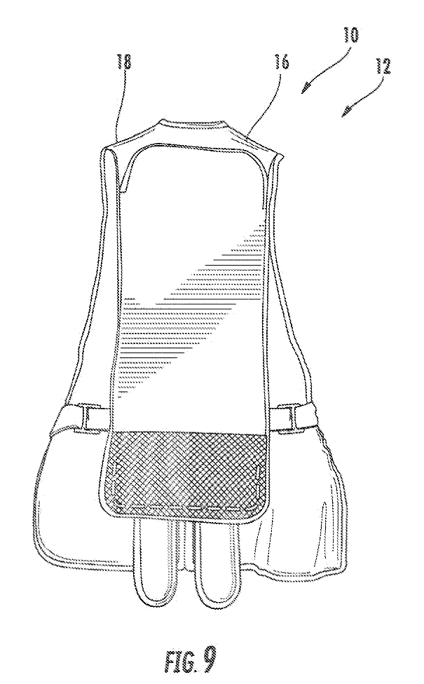

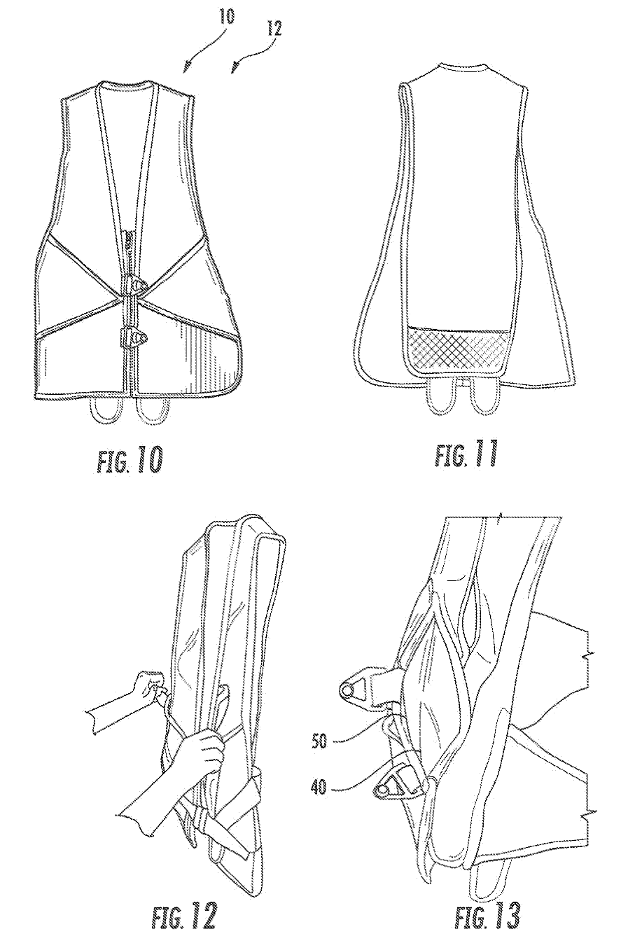

The invention, as shown in FIGS. 1-13 is directed to a gadget harness 10 that provides for the attachment of gadgets and implements useful for a particular task. The gadgets may be attached in positions that are effective ergonomic positions on the harness 10, thereby making the gadgets readily available such that the gadgets can be retrieved with minimal motion while minimizing, if not eliminating, the possibility of losing or dropping the gadget. The gadget harness 10 is also designed to be customized for whatever specific task is at hand, such as, but not limited to applications including hunting, fishing, working, etc. In at least one embodiment, the gadget harness 10 may have an integrated safety harness enabling the gadget harness 10 to be used as a part of a fall arrest system 12 thereby giving a user multiple benefits and reduced bulkiness of separate systems.

The gadget harness 10 may have integrated retractable cords 14. The retractable cords 14 may have any appropriate configuration, such as, but not limited to, the cords being elastic for retraction or being spooled onto a reel. Gadgets can be attached to the retractable cords 14 via a hook, cinch down lanyard, hook and loop fasteners, or other appropriate devices. Retractable cords 14 may be strategically placed and installed inside the gadget harness 10 rather than attached to the outside in order to eliminate the bulk and interference of the retractable cord 14 and housing if attached on the outside. These cords 14 may be strategically placed at top left 16 and right shoulders 18 and underneath the edge of the front pockets so they are concealed and/or out of the way. The retractable cords 14 may be positioned in other appropriate positions as well. One or more retractable cords 14 may be incorporated into the harness 10 and may have clips and/or gadget bands 20 (such as a small, wide rubber band) placed on the ends of the cords 14 to secure the gadget attached. A gadget band 20 may provide elasticity for accommodating variable diameters of gadgets (can calls, grunt calls, etc.) as well as improved grip that is created through use of the rubber material and quiet attachment to the implement. Knob locks 22 may be placed for attaching gear like a removeable bow strap.

The gadget harness 10 may be formed from left and right front adjustable shoulder straps 24, 26 and a partial back pad 28, which may be, but is not limited to about eight inches wide, that is connected primarily by a strap 30, such as one or more elasticized chest straps or elastic connectors, at the sides or waist for a body conforming, comfort fit that has the effect of somewhat compressing the garment underneath to keep it out of the way of the task being performed for greater safety or effectiveness. The left and right front sections 32, 34 may be joined together with a releasable connector 36, such as, but not limited to, a zipper, such as a heavy duty zipper, adjustable elastic webbing with clips or other appropriate configuration. Elastic material may be included in the gadget harness 10 for comfort at sides that both conforms to and gives with a user's body instead of a full vest that is nonconforming, cumbersome and bulky, possibly interfering with the task being performed. The lengths of the shoulder straps 24, 26 may be adjustable to tighten the shoulder straps 24, 26 against the user around which the gadget harness 10 is attached. The waist strap 38 enables the gadget harness 10 to stay close to the body, somewhat compressing the garments underneath the harness. The waist strap 38 also keeps the harness, tools and clothing located underneath the harness 10 out of the way while hunting, fishing or working for safety and/or effectiveness. The gadget harness 10 may be constructed without material 42, such as fabric, extending under a users' arms between front and back sections, thereby forming a harness design as opposed to a vest design. Such configuration provides for continued access to pant and jacket pockets on the clothing worn underneath the gadget harness 10.

The gadget harness 10 can have multiple layered pockets 40 that may be the full length of the front panel accessible via an openable closure mechanism 44, such as, but not limited to, a zipper or buckles. The inner pockets 40 may be configured such that the bottom front-center edge 46 has an angled stitch line or zipper, or both to prevent items from failing out. These layered pockets 40 are accessible from the center-front of the left and right fronts ergonomically with left hand accessing right front and right hand accessing left front. Outer pockets 48 may be ergonomically placed with a top edge having about a 45 degree angled opening towards the center front for easy access with minimal movement. For instance, a left hand of a user may easily access a right pocket 48 and a right hand of a user may easily access a left pocket 48.

In the embodiment including the fall arrest system 12, the adjustable shoulder straps 24, 26 may be accessible via a zipper or other closure. The fall arrest system 12 may be positioned between a bottom layer and a second layer of material 42 forming the gadget harness 10 simplifying the use of the harness 10 and keeping the straps out of the way. A full length front pocket 48 may be positioned between second and third layers. In one embodiment, the third layer may be formed from a shell material. A half or full body length pocket may be positioned between the third layer and a fourth layer. The half or full body length pocket may be formed from a stretchable material, such as, but not limited to, SPANDEX. Gadget loops 50 may be positioned inside the half body length pockets. The loops 50 may be sized to contain ammunition, calls, flashlights, and other such items. The half or full length pockets 48 may have an opening with a 45 degree angle for easy ergonomic access by the opposite hand, thereby providing for access with minimal movement by the user. A small pocket 48 for external storage may be positioned on the top of the fourth layer. A hand warming pocket may be located behind the third layer and may be lined with fleece.

The gadget harness 10 may include one or more gadget knob locks 22 for attaching various devices to the gadget harness 10. In particular, gadget knob locks 22 may be formed from posts attached to ears extending from a lower portion of a back portion of the gadget harness 10. A removable bow strap 52 may be attached to the gadget knob locks 22 to attach a bow to the gadget harness 10 such that the gadget harness 10 functions as a backpack and the bow is secured to the back of the gadget harness 10.

In the embodiment in which the gadget harness 10 has an integrated fall arrest system 12, the gadget harness 10 and fall arrest system 12 may include the following features. The shoulder straps 24, 26 of the fall arrest system 12 and the waist belt 38 may be configured such that in the event of a fall, the connections between the waist belt 38 and the shoulder straps 24, 26 on the front of the fall arrest system 12 fail and separate to prevent the waist strap 38 from being jerked upwardly on a person and possibly causing injury. In particular, the shoulder straps 24, 26 may be positioned in front of the waist belt 38 of the fall arrest system 12. The waist belt 38 may be formed from webbing. An elastic or webbing channel may be created on the shoulder straps 24, 26 through which the waist webbing may be placed. The waist belt 38 may be positioned inside of the shoulder straps 24, 26, such as between the shoulder straps 24, 26 and the user. In the event of a fall, the shoulder straps 24, 26 are pulled upwardly as slack is taken out of the system. The shoulder straps 24, 26 form a straight line of support from the first and second front support strap straps 54, 56 to the shoulder straps 24, 26 on the front of the fall arrest system 12. The weak connection between the front portions of the shoulder straps 24, 26 and the waist belt 38 fails enabling the shoulder straps 24, 26 to straighten and support the person in the suspension seat 58 without jerking the waist belt upwardly, thereby preventing injury to the user. Such component effectively prevents injury to the user.

The shoulder straps 24, 26 may be attached at the back of the waist belt 38 on the left and right side of center and attach to the front on the top of the first and second front support strap straps 54, 56 which positions a user in a seated position during a fall. The back of the shoulder strap has two breakaway loops 60, which may be S-folds, that enable the suspension seat 58 to be moved between a stored position in which the suspension seat 58 is generally aligned with a backside of a user, such as generally vertically, and a deployed position in which the suspension seat 58 is horizontal and capable of functioning as a seat to support the user during a fall. The breakaway loops 60 may be attached with a breakable connector 62, such as, but not limited to, tacks and stitching. The breakable connectors 62 break during a fall when tension is placed on the breakaway loops 60. During a fall, after the two breakaway loops 60 have opened, the opened loops 60 increase the effective strap length up to about eight inches in the back causing the back of the suspension seat 58 to drop about eight inches, such as, between five and eleven inches, while the front of the suspension seat 58 remains in the same position, thereby forming a suspension seat 58 in a horizontal position. In this position, a user may be positioned in a seated position in the event of a fall.

The shoulder straps 24, 26 may have handles 64 that can be utilized by the user in the event of a fall. The user can grab onto the handles 64 and help redistribute their weight in the suspension seat 58 so to avoid blood circulation from being cut off and promote blood circulation throughout the body in the event the user has to stay in the deployed suspension seat 58 for an extended period of time.

The first and second front support straps 54, 56 may extend from a first lower corner of the suspension seat 58 to a front portion of the adjustable waist strap 38. The first and second front support straps 54, 56 may have any appropriate configuration, such as but not limited to being padded. The first and second front support strap straps 54, 56, may be adjustable. In one embodiment, the first and second front support strap straps 54, 56 may be adjustable with a cam buckle or other appropriate device. The first and second front support strap straps 54, 56 may include a cushioned region that runs across the back of the leg, which can be formed from a foam mesh that allows breathing and cushioning. The first and second front support strap straps 54, 56 may be interlaced with the webbing and/or elastic straps in the suspension seat 58 providing strength and greater area for weight distribution, which aids in promoting greater circulation and comfort. The first and second front support strap straps 54, 56 may also aids in minimizing circulation being cut off due to a small strap running across an area with great pressure for a prolonged period of time.

The fall arrest system 12 may include a suspension seat 58, which may also be referred to as an integrated suspension relief seat (SRS), that distributes weight across the seat 58 of the fall arrest system 12 in the event the user has to remain in the deployed fall arrest system 12 for an extended period of time. The suspension seat 58 may form more area for distribution of weight across the seat area and may be comprised of webbing and elastic or a combination of webbing and elastic. The first and second front support strap straps 54, 56 may be interlaced through the one or more webbing or elastic straps forming the suspension seat 58. The suspension seat 58 may also be attached to the sides of the waist strap 38. When deployed, the side takes on the configuration of a swing. The combination of elastic at the sides and webbing at the front creates more of a cradling effect once deployed. This element provides potentially life saving benefits.

A decelerator system 66 may be included and may be automatically deployed in the event of a fall. The decelerator system 66 may take about ½ of the impact force out of the fall when compared to the same deployed system without the decelerator system 66. The decelerator system 66 may be formed from a plurality of s-folds or other such breakaway system. The decelerator system 66 may be positioned between the shoulder straps 24, 26 and secure item, such as a tree or other such item.

In at least one embodiment, a self extraction ladder 68 may be attached to the tether 70 effectively off line from the tether 70 such that it is automatically deploys in the event of a fall but may also be accessed to be deployed manually if necessary. It is attached such that the self extraction ladder 68 is automatically deployed in close proximity of the user enabling the user to grab the ladder 68 while suspended after the fall. The user can then climb up, disconnect the fall arrest system 12 from the tree and climb down to safety. The self extraction ladder 68 thus may enable self extraction by the user.

In the event of a fall, the initial force of the fall breaks the deployment mechanism (breakaway stitch, snap, etc.) which have variable breaking forces and may be adjusted for varying size harnesses for varying size and weight users. For example, the breakaway stitch tested, breaks with a shearing force of 700 lbs. This force is effected at the beginning of a fall. It causes the self extraction ladder 68 to deploy in the direction the user is falling, which is important because it provides for the self extraction device to be in close proximity to the user rather than on the opposite side of a tree for example. This element provides potentially life saving benefits.

In another embodiment, the user may attach a climbing belt 72 to a webbed coupling 72 on the waist belt 38 by looping it onto one side and connecting the other side via a carabiner. When used as a climbing belt 72, the climbing belt 72 may be attached to the webbed coupling 72 which are uniquely placed not at the left and right side of the body, but closer to center so to provide greater comfort when climbing. Placing the webbed coupling 72 forward of the side-waist allows the climbing belt 72 to pull from the waist and first and second front support strap straps 38, 54, 56 of the fall arrest system 12 instead of digging into the waist and creating lower back pressure. When the climbing belt 72 is attached to both left and right webbed couplings 72, in the event of a fall, the climbing belt 72 may be adjusted to a length that will provide the user a place their knees or feet to redistribute their weight once the suspension seat 58 is deployed. The user can then adjust it so he can stand up on it for another option. The user may stand up on the strap to minimize pressure experienced from the waist or first and second front support strap straps 38, 54, 56. Doing so, aids in promoting circulation if the user is suspended in the harness for a prolonged period of time. With the greater comfort provided by the suspension seat 58 and the option of standing on the climbing belt 72, the user may more comfortably access his communication device to call for help, or begin to self extract.

The fall arrest system 12 may also include an emergency response system. The emergency response system may automatically deploy during a fall utilizing the same break away mechanism in the form of a stitch, snap, etc. that provides access to the emergency response system that is attached to the tether effectively offline from the tether in such a way that it only deploys in the event of a fall; but may be accessed in a way to be manually deployed if necessary. Any appropriate emergency locator system, such as an EPRIB, may be used. In at least one embodiment, the emergency locator system may transmit an emergency signal upon deployment to a satellite or other receiving station. The signal may be processed and compared with stored information to determine the location of the user, their name, address, existing medical conditions, emergency contact information and may initiate contact with listed emergency contacts.

The fall arrest system 12 may be attached to a tree with a tether 70 and may be attached to the harness from the front or the back. The tether 70 may be any appropriate tether, such as, but not limited to the tether 70 disclosed in Published US Patent Application US 2006/0169534. The tether 70 may include one or more devices in an offline position such that during normal use of the tether 70, the devices are not susceptible to wear. For instance, the tether 70 may include one or more deceleration systems as set forth in US 2006/0169534. The decelerator 66 may be held offline by being attached inline with the tether 70 and offline by attached portions of the tether 70 above and below the decelerator 66 together with a breakaway tack. When the tether 70 undergoes a force great enough to break the releasable connector 36, such as about 700 pounds in one embodiment, the releasable connector 36 breaks and places the decelerator 66 system inline. Similarly, other devices, such as, but not limited to, a self extraction ladder 68, an emergency locator system such as an EPIRB, a life raft, or other such device, may be positioned offline relative to the tether 70. These devices may also, in other embodiments, be configured for manual deployment as well. This element certainly has life saving benefits.

In other embodiments, the gadget harness 10 may be used separately from the fall arrest system 12. The gadget harness 10 may be combined with other harness systems such as the harnesses discloses in U.S. Pat. No. 7,051,836 and U.S. Pat. No. 7,063,185.

The gadget harness 10 may include a strap 74 positioned on an outer surface of the waist strap 38. The strap 74 may extend from a first front side around the side, across the back and around the opposite side, terminating at a second opposite front side. The strap 74 may also be attached in the middle of the back, thereby creating an extended loop on each side. Various removable pockets or other removable devices may be attached to the extended loops. Because the loops are only attached to the front sides and at the center of the back, the items attached to the loops may be slide between the front and back and placed in a desired position with ease.

The foregoing is provided for purposes of illustrating, explaining, and describing embodiments of this invention. Modifications and adaptations to these embodiments will be apparent to those skilled in the art and may be made without departing from the scope or spirit of this invention.

1. A fall arrest system, comprising:
a plurality of shoulder straps coupled to an adjustable waist belt;
a suspension seat formed from a platform that is suspended beneath the adjustable waist belt such that the suspension seat is positioned generally vertically with straps that include breakable connections;
a first strap extends between the suspension seat and a rear portion of the adjustable waist belt, wherein the first strap is attached to the suspension seat proximate to a first, upper corner of the suspension seat and wherein the first strap includes at least one first loop affixed with a breakable connection;
a second strap extends between the suspension seat and a rear portion of the adjustable waist belt, wherein the second strap is attached to the suspension seat proximate to a second, upper corner of the suspension seat and wherein the second strap includes at least one second loop affixed with a breakable connection;
at least one first front support strap extending from a first lower corner of the suspension seat to a front portion of the adjustable waist strap;
at least one second front support strap extending from a second lower corner of the suspension seat to a front portion of the adjustable waist strap;
wherein the suspension seat is positioned generally vertically prior to a fall; and
wherein the at least one first and second loops are sized such that after a fall, the breakable connections break and the suspension seat is positioned in a generally horizontal position.

2. The fall arrest system of claim 1, wherein at least one of the shoulder straps is adjustable.

3. The fall arrest system of claim 1, further comprising a chest strap extending between the shoulder straps on a front side positioned proximate to a user's chest.

4. The fall arrest system of claim 1, wherein the plurality of shoulder straps are coupled to a back pad positioned proximate to a user's upper back.

5. The fall arrest system of claim 1, further comprising a coupling on each hip of the adjustable waist strap to which a climbing belt is attached.

6. The fall arrest system of claim 1, wherein the at least one first and second front support straps are adjustable.

7. The fall arrest system of claim 1, further comprising fabric layers attached to front and rear sides of shoulder straps, wherein side areas under a user's arms between the front and rear sides are open.

8. The fall arrest system of claim 7, further comprising pockets in the outer surface of the fabric layers.

9. The fall arrest system of claim 7, further comprising an automatically deployable self extraction ladder.
